(19) United States
(12) Patent Application Publication
(10) Pub. No.: US 2025/0329959 A1
(43) Pub. Date: Oct. 23, 2025

(54) WATERPROOF ADAPTER ASSEMBLY AND WATERPROOF ADAPTER THEREOF

(71) Applicant: F TIME TECHNOLOGY INDUSTRIAL CO., LTD., New Taipei City (TW)

(72) Inventors: Chang-Lin PENG, New Taipei City (TW); Chih-Min PENG, New Taipei City (TW); Yu-Han HUANG, New Taipei City (TW)

(21) Appl. No.: 18/643,309

(22) Filed: Apr. 23, 2024

(51) Int. Cl. H01R 13/52; H01R 13/04; H01R 13/10; H01R 13/502

(52) U.S. Cl. CPC H01R 13/5202; H01R 13/04; H01R 13/10; H01R 13/502

(57) ABSTRACT

A waterproof adapter assembly has two waterproof adapters. Each one of waterproof adapters has a main casing, an outer casing, an insulative component, a waterproof rubber ring, a jacketing set, and a center pin set. The main casing is a hollow shell, and has a first annular surface. The outer casing is sleeved on the main casing. The insulative component is mounted in the main casing, and has a second annular surface. The first annular surface encircles the second annular surface. The waterproof rubber ring is mounted on the first annular surface and the second annular surface. The jacketing set is mounted in the main casing, and pushes the waterproof rubber ring toward the first annular surface and the second annular surface. The center pin set is mounted through the insulative component and is spaced apart from the first waterproof rubber ring.

### BACKGROUND OF THE INVENTION

### 1. Field of the Invention

The present invention relates to an adapter, especially to a waterproof adapter.

### 2. Description of the Prior Arts

With reference to FIG. 11, a conventional waterproof adapter comprises an outer casing 90, a main casing 91, a first insulative component 92, a second insulative component 93, a center pin set 94, a waterproof rubber ring 95 and a jacketing set 96. The main casing 91 is mounted in the outer casing 90. The first insulative component 92, the waterproof rubber ring 95, and the second insulative component 93 are sequentially mounted in the main casing 91. The center pin set 94 is mounted through the first insulative component 92, the waterproof rubber ring 95, and the second insulative component 93. The center pin set 94 comprises an annular barb. The annular barb is encircled by and abuts against the second insulative component 93, which prevents moisture from entering through the gap between the center pin set 94 and the second insulative component 93 and affecting the conductors connected to the waterproof adapter. The jacketing set 96 pushes forward against the second insulative component 93 from a back side thereof, such that the first insulative component 92, the waterproof rubber ring 95, and the second insulative component 93 can be securely mounted in the main casing 91.

However, since the first insulative component 92 and the second insulative component 93 are usually made of resilient materials, and the waterproof rubber ring 95 is made of soft materials, when the jacketing set 96 pushes forward against the second insulative component 93 from the back side, the first insulative component 92, the waterproof rubber ring 95, and the second insulative component 93 are compressed to varying degrees, the arrangement of the first insulative layer 92, the waterproof rubber ring 95, and the second insulative layer 93 may be prone to be skewed, which affects the connection of the center pin set 94 when connected to the other signal connector, thus decreasing stability of the signal transmission. The waterproof rubber ring 95 typically comprises weak electrical conductivity, and because the center pin assembly 94 contacts the waterproof rubber ring 95, the waterproof rubber ring 95 may reduce the electrical conductivity efficiency of the center pin set 94. It is still possible for moisture to permeate through the gap between the annular barb of the center pin set 94 and the second insulative component 93 and affect the conductor connected to the waterproof adapter.

To overcome the shortcomings, the present invention provides a waterproof adapter assembly and its waterproof adapter to mitigate or obviate the aforementioned problems.

### SUMMARY OF THE INVENTION

The main objective of the present invention is to provide a waterproof adapter assembly, which can reduce the interference of the insulating component with the center pin set, and improve the engagement of the center pin assemblies in the two waterproof adapters of the waterproof adapter assembly.

The waterproof adapter assembly comprises two waterproof connectors that can be disassembled and connected.

A waterproof adapter comprises a main casing, an outer casing, an insulative component, a first waterproof rubber ring, a jacketing set, and a center pin set.

The main casing is a hollow shell and comprises a first annular surface. The outer casing is sleeved on an outer side of the main casing. The insulative component is mounted in the main casing and comprises a second annular surface. The first annular surface encircles the second annular surface. The first waterproof rubber ring abuts against the first annular surface and the second annular surface. The jacketing set is mounted in the main casing and pushes the first waterproof rubber ring toward the first annular surface and the second annular surface. The center pin set is mounted through the insulative component and is spaced apart from the first waterproof rubber ring.

When the two waterproof adapters are connected, the center pin assemblies of the two waterproof adapters form an electrical connection.

The advantage of the present invention is that when the jacketing set is pressed by the waterproof rubber ring and is not pushed to the insulative component, the deflection of the insulative component will be reduced without interfering with the center pin set. In this way, the position of the center pin set is not shifted, so as to improve the bonding between the first center pin set and the second center pin set, thereby improving the quality of the signal transmission.

Other objectives, advantages and novel features of the invention will become more apparent from the following detailed description when taken in conjunction with the accompanying drawings.

### BRIEF DESCRIPTION OF THE DRAWINGS

FIG. 1 is a sectional view of a waterproof adapter assembly in accordance with a first embodiment of the present invention;

FIG. 2 is a perspective view of the waterproof adapter assembly in FIG. 1;

FIG. 3 is a sectional view of a first waterproof adapter of the waterproof adapter assembly in FIG. 1;

FIG. 4 is an exploded view of the first waterproof adapter in FIG. 1;

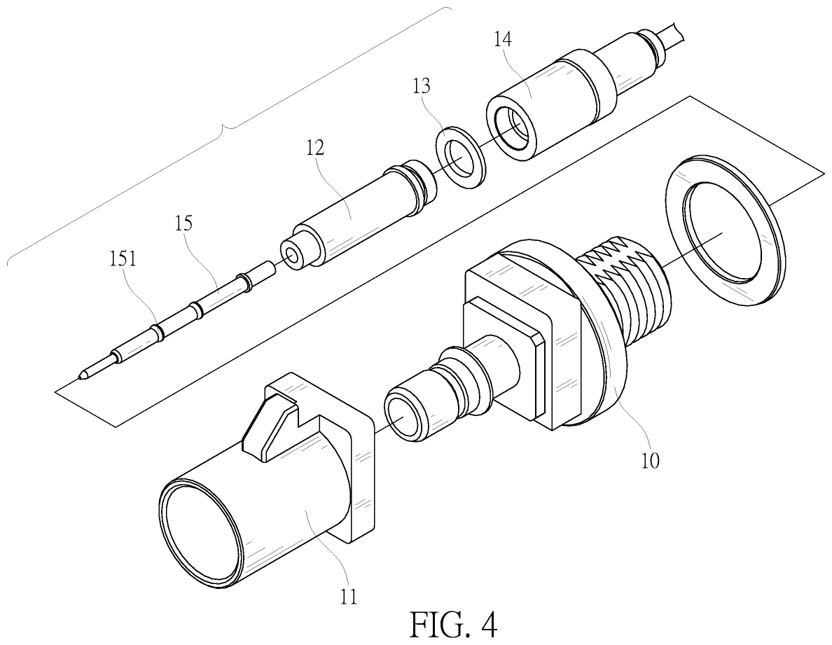

FIG. 5 is a partial enlargement view of the first waterproof adapter in FIG. 1;

FIG. 6 is a sectional view of a second waterproof adapter of the waterproof adapter assembly in FIG. 1;

FIG. 7 is an exploded view of the second waterproof adapter in FIG. 1;

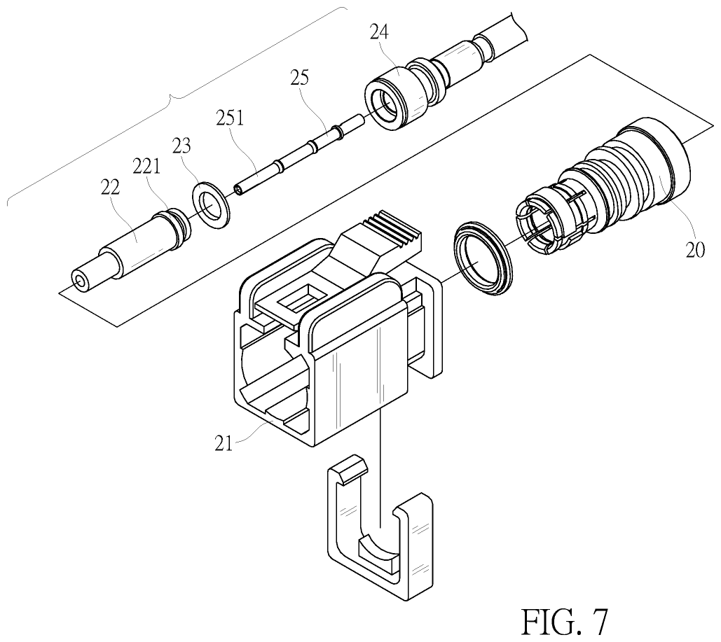

FIG. 8 is a partial enlargement view of the second waterproof adapter in FIG. 1;

FIG. 9 is an exploded view of a first waterproof adapter of the waterproof adapter assembly in accordance with a second embodiment;

FIG. 10 is an exploded view of a second waterproof adapter of the waterproof adapter assembly in accordance with the second embodiment in FIG. 9; and

FIG. 11 is a sectional view in accordance with a conventional waterproof adapter.

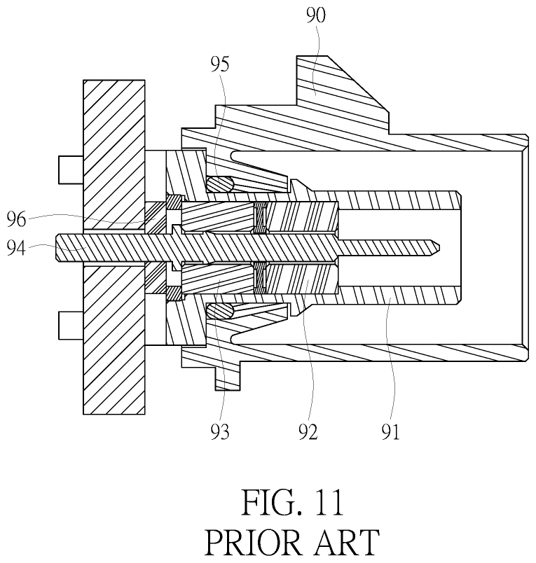

### DETAILED DESCRIPTION OF THE PREFERRED EMBODIMENTS

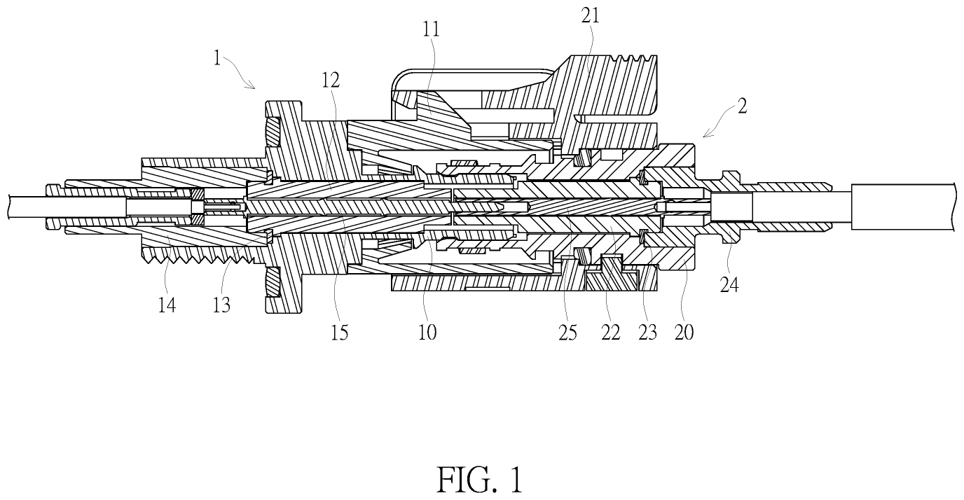

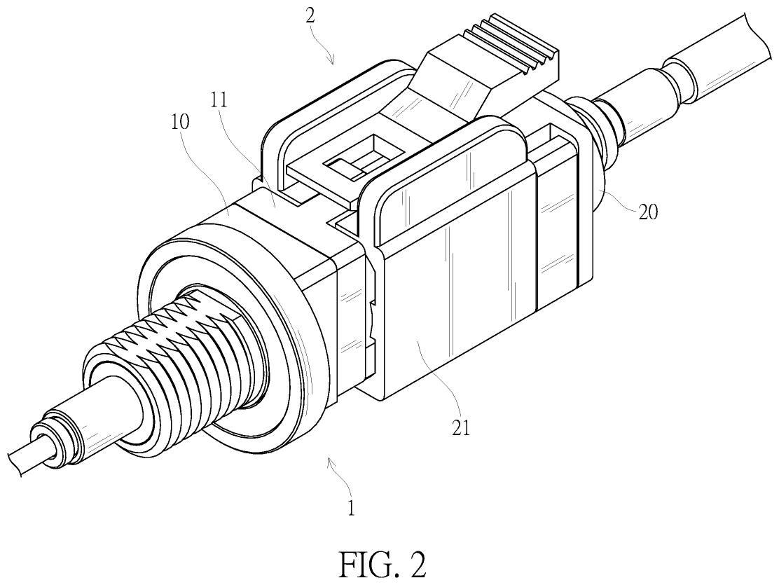

With reference to FIG. 1 and FIG. 2, the present invention provides a waterproof adapter assembly comprising a first waterproof adapter 1 and a second waterproof adapter 2.

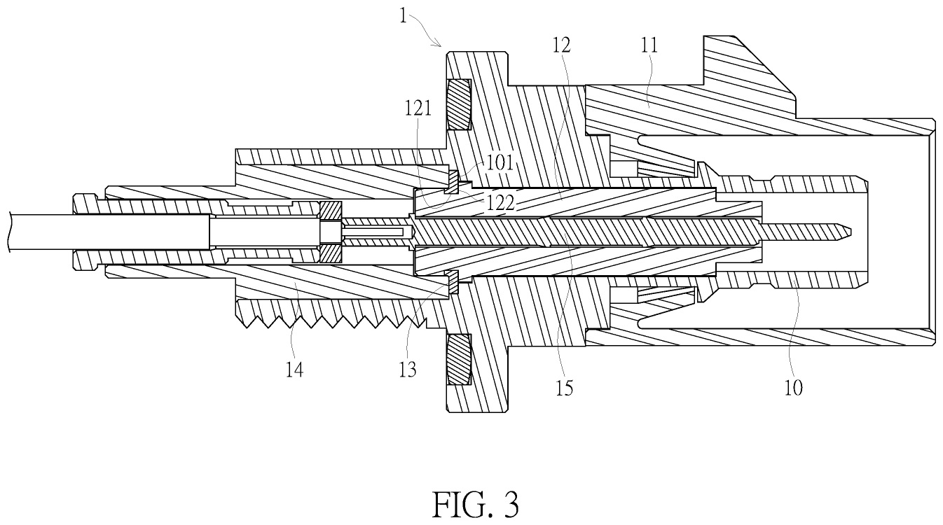

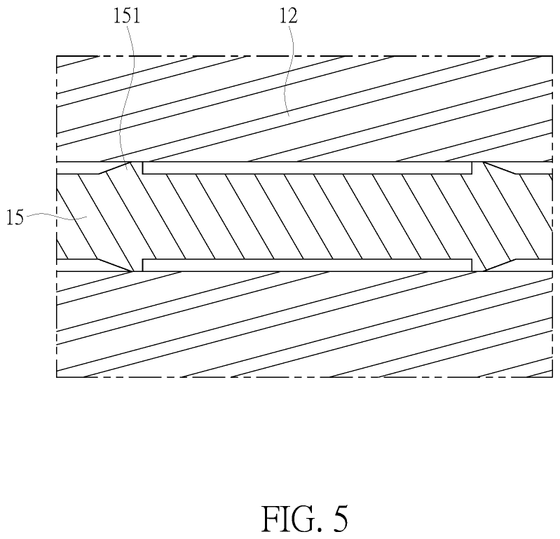

With reference to FIG. 3 and FIG. 5, in the first embodiment, the first waterproof adapter 1 comprises a first main casing 10, a first outer casing 11, a first insulative component 12, a first waterproof rubber ring 13, a first jacketing set 14, and a first center pin set 15.

The first main casing 10 is a hollow shell and comprises a first annular surface 101 on an inner wall of the first main casing 10. In this embodiment, the first annular surface 101 is perpendicular to an axial direction of the first waterproof adapter 1, but not limited to this. In other words, in this embodiment, the first annular surface 101 comprises a stepped structure on the inner wall of the first main casing 10.

The first outer casing 11 is sleeved on the first main casing 10. The first insulative component 12 is mounted in the first main casing 10 and comprises a first ring groove 121. The first ring groove 121 comprises a second annular surface 122. In this embodiment, the second annular surface 122 is perpendicular to the axial direction of the first waterproof adapter 1, but not limited to this. The first annular surface 101 encircles the second annular surface 122.

The first waterproof rubber ring 13 can be mounted in the first ring groove 121, so that the first waterproof rubber ring 13 can abut the first annular surface 101 and the second annular surface 102. In this embodiment, the first jacketing set 14 is mounted through the first main casing 10 and pushes the first waterproof rubber ring 13 toward the first annular surface 101 and the second annular surface 122, so that the first waterproof rubber ring 13 seals and abuts the first annular surface 101 and the second annular surface 122. Meanwhile, the force of the first jacketing set 14 pushing the first waterproof rubber ring 13 may be dispersed across the first annular surface 101 of the first main casing 10 and the second annular surface 122 of the first insulative component 12. Therefore, the force on the first insulative component 12 is smaller, and the deformation of the first insulative component 12 is smaller.

The first center pin set 15 may be an integrally formed conductor, and the first center pin set 15 is mounted through the first insulative component 12. The first center pin set 15 comprises two first annular barbs 151 (shown in FIG. 5). The two first annular barbs 151 are opposite to each other, and encircle and hook to the inner wall of the first insulative component 12. Precisely, the first annular barbs 151 are tilted in the opposite directions to each other, thereby preventing moisture from permeating through the gap between the first annular barb 151 and the first insulative component 12 along the tilt direction.

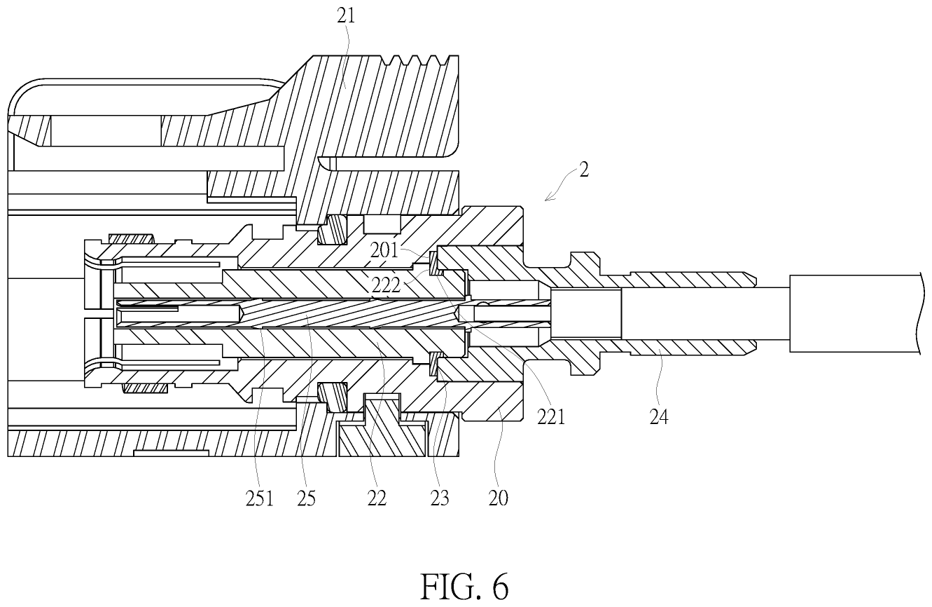

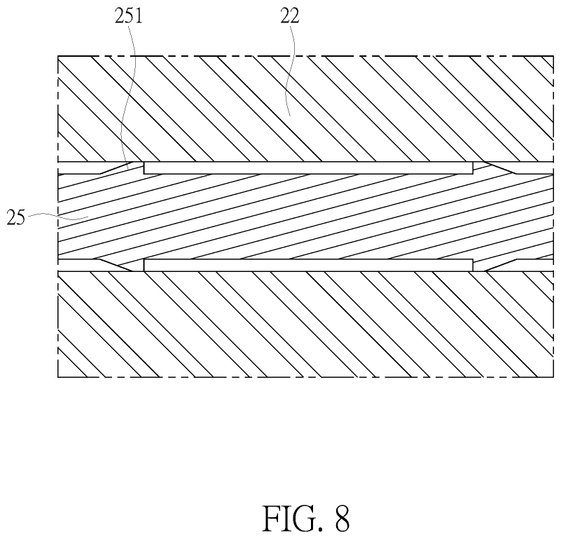

With reference to FIG. 6 and FIG. 8, the second waterproof adapter 2 is similar in construction to the first waterproof adapter 1, and is detachably connected to the first waterproof adapter 1. The second waterproof adapter 2 comprises a second main casing 20, a second outer casing 21, a second insulative component 22, a second waterproof rubber ring 23, a second jacketing set 24, and a second center pin set 25.

The second main casing 20 is a hollow shell and comprises a third annular surface 201 on an inner wall of the second main casing 20, and the third annular surface 201 is perpendicular to an axial direction of the second waterproof adapter 2. The second outer casing 21 is sleeved on the second main casing 20. The second insulative component 22 is mounted in the second main casing 20 and comprises a second ring groove 221. The second ring groove 221 comprises a fourth annular surface 222. The third annular surface 201 encircles the fourth annular surface 222. The third annular surface 201 and the fourth annular surface 222 may be perpendicular to the axial direction of the second waterproof adapter 2 and flush with each other. The second waterproof rubber ring 23 is mounted in the second ring groove 221. The second jacketing set 24 is mounted in the second main casing 20 and pushes the second waterproof rubber ring 23 toward the third annular surface 201 and the fourth annular surface 222, such that the second waterproof rubber ring 23 seals and abuts the third annular surface 201 and the fourth annular surface 222.

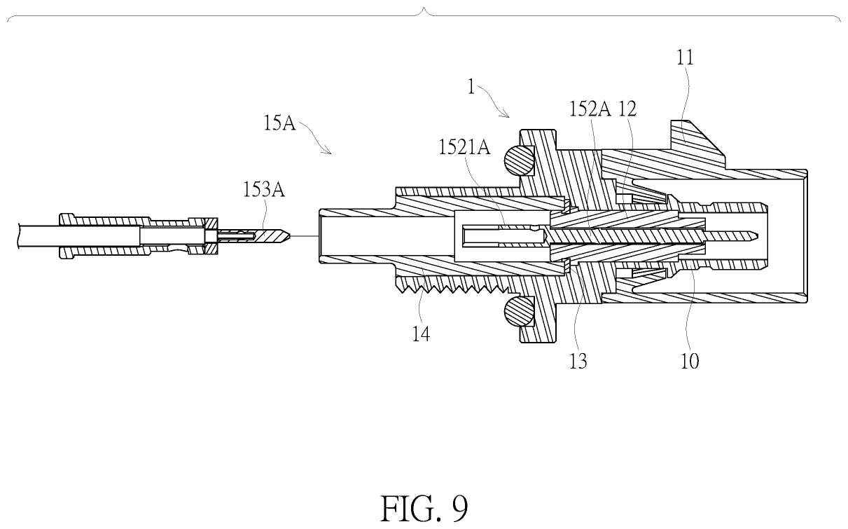

The second center pin set 25 is mounted through the second insulative component 22. The second center pin set 25 comprises two second annular barbs 251 (shown in FIG. 9). The two second annular barbs 251 are opposite to each other, and encircle and hook to the inner wall of the second insulative component 22. The second annular barbs 251 are tilted in the opposite directions to each other, thereby preventing moisture from permeating through the gap between the second annular barb 251 and the second insulative component 22 along the tilt direction.

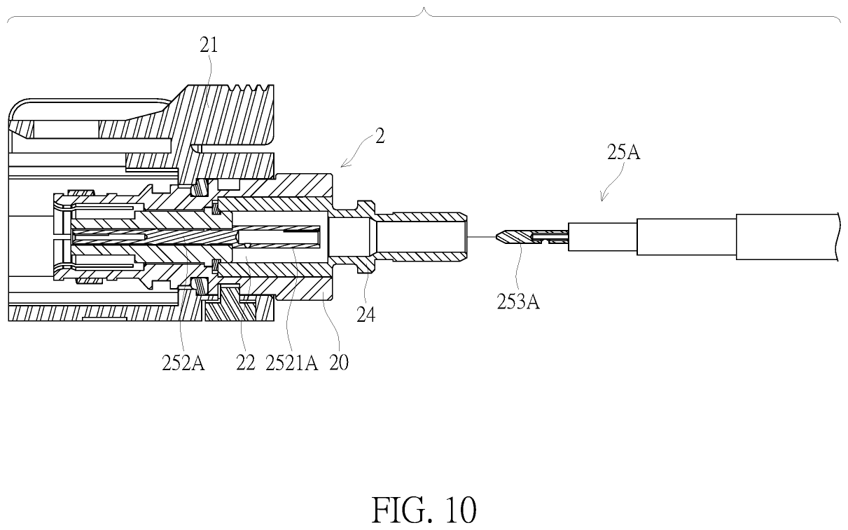

Then please refer to FIG. 9 and FIG. 10. In the second embodiment, the technical features are similar to the first embodiment, but the difference is only that in the second embodiment either of the center pin sets may be divided into two pins.

In the second embodiment, the first center pin set 15A of the first waterproof adapter 1 is divided into a receiving segment 152A and a connection segment 153A. The receiving segment 152A is mounted through the first insulative component 12 and comprises a connection hole 1521A. The connection segment 153A is detachably and electrically connected to the connection hole 1521A of the receiving segment 152A. The second center pin set 25 of the second waterproof adapter 2 includes a receiving segment 252A and a connection segment 253A. The receiving segment 252A is mounted through the second insulative component 22 and comprises a connection hole 2521A. The connection segment 253A is detachably and electrically connected to the connection hole 2521A of the receiving segment 252A.

Accordingly, in the case that two devices are connected to each other through the waterproof adapter assembly, when one of the devices is replaced with the other device, the connected device can be replaced in the quickest and most convenient way by pulling out the receiving segment 152A/252A and inserting the connection segment 153A/253A of the other device back into the receiving section 152A/252A.

The advantage of the present invention is that when the jacketing set is squeezed by the waterproof rubber ring and is not pushed to the insulative component, the deflection of the insulative component will be reduced without interfering with the center pin set. In this way, the position of the center pin set is not shifted, so as to improve the bonding between the first center pin set 15 and the second center pin set 25, thereby improving the quality of the signal transmission. In addition, the annular barb on the center pin set further prevents moisture from permeating through the gap between the center pin set and the insulative component. The ring groove enlarges the contact area of the waterproof rubber ring over the bottom surface of the ring, and during assembly, the waterproof rubber ring can be more securely set in the ring groove to achieve a better sealing and waterproof effect.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A waterproof adapter comprising:
a main casing being a hollow shell and comprising a first annular surface;
an outer casing sleeved on the main casing;
an insulative component mounted in the main casing and comprising a second annular surface; the first annular surface encircling the second annular surface;
a first waterproof rubber ring abutting against the first annular surface and the second annular surface;
a jacketing set mounted in the main casing and pushing the first waterproof rubber ring toward the first annular surface and the second annular surface; and
a center pin set mounted through the insulative component and spaced apart from the first waterproof rubber ring.

2. The waterproof adapter as claimed in claim 1, wherein the center pin set comprises:
two annular barbs tilted in opposite directions to each other.

3. The waterproof adapter as claimed in claim 1, wherein:
the insulative component comprises a ring groove;
the second annular surface is formed in the ring groove; and
the first waterproof rubber ring is mounted in the ring groove.

4. The waterproof adapter as claimed in claim 2, wherein:
the insulative component comprises a ring groove;
the second annular surface is formed in the ring groove; and
the first waterproof rubber ring is mounted in the ring groove.

5. The waterproof adapter as claimed in claim 1, wherein, the center pin set includes:
a receiving segment mounted through the insulative component and comprising a connection hole; and
a connection segment detachably and electrically connected to the connection hole.

6. The waterproof adapter as claimed in claim 4, wherein, the center pin set includes:
a receiving segment mounted through the insulative component and comprising a connection hole; and
a connection segment detachably and electrically connected to the connection hole.

7. The waterproof adapter as claimed in claim 1 further comprising a second waterproof rubber ring, the second waterproof rubber ring sleeved on the main casing.

8. The waterproof adapter as claimed in claim 6 further comprising a second waterproof rubber ring, the second waterproof rubber ring sleeved on the main casing.

9. A waterproof adapter assembly comprising:
a first waterproof adapter comprising:
a first main casing being a hollow shell and comprising a first annular surface;
a first outer casing sleeved on the first main casing;
a first insulative component mounted in the first main casing and forming a second annular surface; the first annular surface encircling the second annular surface;
a first waterproof rubber ring mounted on the first annular surface and the second annular surface;
a first jacketing set mounted in the first main casing and pushing the first waterproof rubber ring toward the first annular surface and the second annular surface;
a first center pin set mounted through the first insulative component, and being spaced apart from the first waterproof rubber ring;
a second waterproof adapter detachably coupled to the first waterproof adapter and comprising:
a second main casing being a hollow shell and comprising a third annular surface;
a second outer casing set outside of the second main casing;
a second insulative component mounted in the second main casing and forming a fourth annular surface; the third annular surface encircling the fourth annular surface;
a second waterproof rubber ring mounted on the third annular surface and the fourth annular surface;
a second jacketing set mounted in the second main casing and pushing the second waterproof rubber ring toward the third annular surface and the fourth annular surface;
a second center pin set mounted through the second insulative component and being spaced apart from the second waterproof rubber ring; wherein, when the second waterproof adapter is coupled with the first waterproof adapter, the second center pin set forms an electrical connection with the first center pin set.

10. The waterproof adapter assembly as claimed in claim 9, wherein:
the second waterproof adapter further comprises:
a third waterproof rubber ring sleeved on the second main casing;
when the second waterproof adapter is coupled with the first waterproof adapter, the third waterproof rubber ring abuts against and seals between the first main casing and the second main casing.
